(19) United States
(12) Patent Application Publication
(10) Pub. No.: US 2007/0103860 A1
(43) Pub. Date: May 10, 2007

(54) Latch device for a tablet personal computer

(75) Inventors: Chien-Sheng Lo, Taipei (TW); Hung-Cheng Lee, Taipei (TW); Ying-Chi Chou, Taipei (TW); Yu-Yuan Chen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/491,898

(22) Filed: Jul. 25, 2006

(30) Foreign Application Priority Data
Nov. 10, 2005 (TW) 94139478

(51) Int. Cl. G06F 1/16

(52) U.S. Cl. 361/683; 361/680

(57) ABSTRACT

A latch device applied in a tablet personal computer is provided. The latch device comprises a first engagement element and a second engagement element. The first engagement element comprises a hook, button and resilient plate. The hook comprises a sliding cavity, a first hole and a second hole. The first hole and the second hole are positioned symmetrically in two ends of the hook. The resilient plate is mounted against the hook. The button includes a bulge and a stopper pressing on the hook. The bulge is passed through the sliding cavity to slide along the long axis up and down. The second engagement element comprises a hollow and protrusion. The protrusion is in the hollow.

### RELATED APPLICATIONS

The present application is based on, and claims priority from, Taiwan Application Serial Number 94139478, filed Nov. 10, 2005, the disclosure of which is hereby incorporated by reference herein in its entirety.

### BACKGROUND

1. Field of Invention

The present invention relates to a latch device for a liquid crystal display. More particularly, the present invention relates to a latch device for a liquid crystal display of a tablet personal computer.

2. Description of Related Art

The technology and manufacturing techniques of notebook computers are becoming better developed with each passing day. The notebook computer has thus become more and more popular. However, because of viewing angle limitations of liquid crystal display of the notebook computer, not all viewers huddled around the notebook computer can clearly view images. The notebook computer display must be repositioned to suit any one particular viewer.

Tablet personal computers have been innovated to overcome this limitation. The screen display of the tablet personal computer not only has a humanized input function but also can be flipped over so that viewers around the tablet personal computer can see the information and images on the screen display more easily than before. The flipping design of the tablet personal computer means that latching a front side or a back side of the liquid crystal display onto a base of the tablet personal computer is an important design feature.

FIG. 1 is a schematic diagram showing a rotatable hook of a conventional tablet personal computer. The tablet personal computer includes a base 104 and a screen display 102. A rotatable hook 106 pivotally configured in the screen display 102 is used to fasten the screen display 102 on a base 104. To open the screen display 102, a user presses a button 108 to release the rotatable hook 106 from a hollow 109 mounted on the base 104, thereby separating the rotatable hook 106 from the hollow 109 and releasing the screen display 102.

However, the rotatable hook of the conventional tablet personal computer is not conveniently operated. For example, after the screen display 102 is turned over, a front side of the screen display 102 is displayed upward. To close the screen display 102, the position of the rotatable hook 106 needs to be changed by hand to fasten the rotatable hook 106 in the hollow 109. Furthermore, the rotatable hook 106 easily scrapes and damages the hollow 109, marring the shell appearance of the tablet personal computer.

### SUMMARY

In one aspect, the embodiment of this present invention provides a latch device applied in a tablet personal computer to latch a front side or a back side of a screen display onto a base to enhance operation convenience.

In another aspect, the embodiment of this present invention provides a latch device applied in a tablet personal computer whose hook can be repositioned quickly after flipping over the first shell element of the tablet personal computer.

In still another aspect, the embodiment of this present invention provides a latch device applied in a tablet personal computer that provides a hook sliding up and down to decrease damage of a hollow and maintain the appearance of the tablet personal computer.

In accordance with the foregoing and other aspects of the present invention, the embodiment of the present invention provides a latch device applied in a tablet personal computer. A tablet personal computer comprises a first shell element and a second shell element. The first shell element has a front side and a back side. The second shell element is pivotally coupled with one end of the first shell element, wherein the first shell element can be flipped over relative to the second shell element to make the front side or the back side toward the second shell element. The latch device comprises a first engagement device and a second engagement device.

The first engagement device is mounted on the first shell element, wherein the first engagement device comprises a hook, a button and a resilient plate. The hook has a sliding cavity, a first hole and a second hole, wherein the first hole and the second hole are positioned symmetrically in two ends of the hook. The sliding cavity comprises a long axis and a short axis. The resilient plate is mounted against the hook. The button includes a stopper and a bulge that protrudes from the stopper and contacts the resilient plate. The stopper presses on the hook and the bulge is passed through the sliding cavity to slide along the long axis of the sliding cavity up and down. Thus, one end having the first hole of the hook protrudes from the front side of the first shell element, or the other end having the second hole of the hook protrudes from the back side of the first shell element.

The second engagement device is mounted on the second shell element, wherein the second engagement device comprises a hollow and a protrusion. The protrusion mounted on the hollow clasps the first hole and the second hole selectively. The protrusion can be a projection according to demands.

Thus, the present invention provides a latch device to latch a front side or a back side of a screen display onto a base to enhance operation convenience. Moreover, the hook of the latch device of the present invention can be repositioned quickly after flipping over the first shell element of the tablet personal computer. Furthermore, the latch device of the present invention provides the hook sliding up and down to protrude from the front side and the back side of the first shell element. Besides, the latch device of the present invention can decrease damage of the hollow and maintain the appearance of the tablet personal computer.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferred embodiment with reference made to the accompanying drawings as follows:

FIG. 1 is a schematic diagram showing a rotatable hook for a conventional tablet personal computer.

FIG. 2 is a schematic diagram showing a latch device of a tablet personal computer according to one embodiment of the present invention.

FIG. 3 is a perspective diagram showing the partial enlarged first engagement 200 according to FIG. 2.

FIG. 4 is a cross-sectional schematic diagram along the A-A line in FIG. 3, showing an engagement of the hook with the protrusion.

FIG. 5 is a cross-sectional schematic diagram along the A-A line in FIG. 3, showing the hook separated from the protrusion.

FIG. 6 is a schematic diagram showing a tablet personal computer with the screen display flipped over according to one embodiment of the present invention.

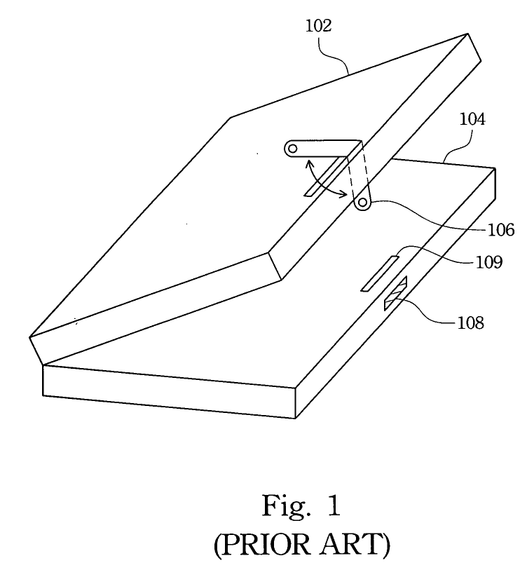

### DESCRIPTION OF THE PREFERRED EMBODIMENTS

The present invention provides a latch device to flip a front side or a back side of a liquid crystal display onto a base to enhance operation convenience. Reference is now made in detail to the present preferred embodiments of the invention, examples of which are illustrated in the accompanying drawings. Wherever possible, the same reference numbers are used in the drawings and the description to refer to the same or like parts.

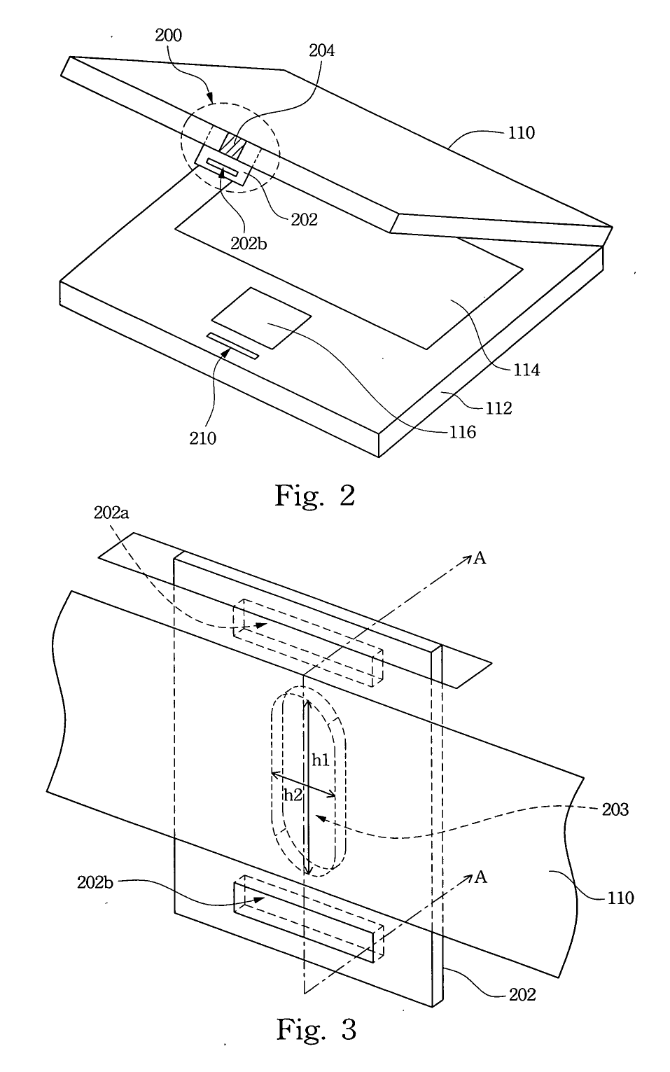

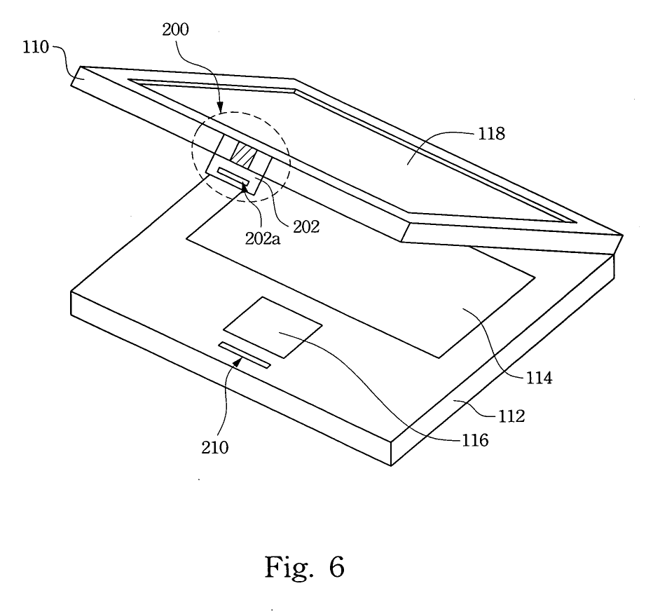

FIG. 2 is a schematic diagram showing a latch device of a tablet personal computer according to one embodiment of the present invention. In FIG. 2, a tablet personal computer comprises a first shell element 110 and a second shell element 112. The first shell element 110 includes a screen display 118 (shown in FIG. 6) and a first engagement device 200. The second shell element 112 comprises a keyboard 114, a touch panel 116 and a second engagement device 210. The first shell element 110 is fastened on the second shell element 112 by clasping the first engagement device 200 with the second engagement device 210.

FIG. 3 is a perspective diagram showing the partial enlarged first engagement 200 according to FIG. 2, but omitting a button 203. A hook 202 is configured in the first shell element 110. The hook 202 has a sliding cavity 203, a first hole 202a and a second hole 202b that are positioned symmetrically in two ends of the hook 202. The sliding cavity 203 has a long axis h1 and a short axis h2. The hook 202 is slid up and down along the long axis h1 of the sliding cavity 203 to protrude from a front side or a back side of the first shell element 110. In FIG. 2 and FIG. 3, the hook 202 is protruded from the back side of the first element 110.

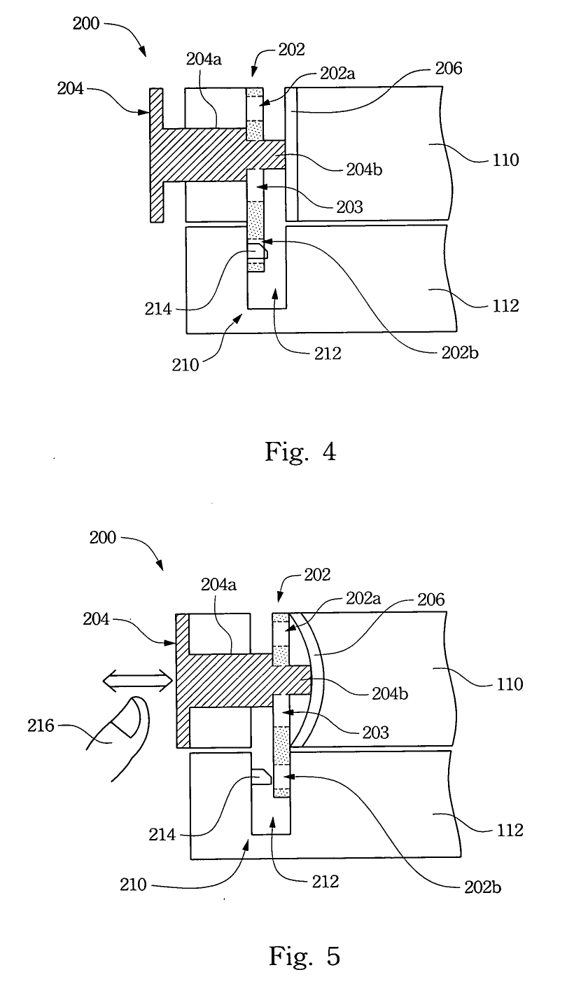

FIG. 4 is a cross-sectional schematic diagram along the A-A line in FIG. 3, showing an engagement of the hook with the protrusion. The first engagement device 200 configured in the first shell element 110 comprises a button 204, a hook 202 and a resilient plate 206. The button 204 has a stopper 204a and a bulge 204b protruded from the stopper 204a. The width of the stopper 204a is larger than the short axis h2 of the sliding cavity 203 to touch on the sidewall thereof. The bulge 204b protrudes through the sliding cavity 203 and contacts the resilient plate 206. The resilient plate 206 is located against the hook 202.

The second engagement device 210 configured in the second shell element 112 comprises a hollow 212 and a protrusion 214. The protrusion 214 is mounted in the hollow 212 to clasp the first hole 202a and the second hole 204b of the hook 202 selectively.

FIG. 5 is a cross-sectional schematic diagram along the A-A line in FIG. 3, showing the hook separated from the protrusion. When the button 204 is pressed by finger 216, the stopper 204a of the button 204 pushes the hook 202 and the resilient plate 206 inside the first shell element 110 to move the hook 202 backward and deform the resilient plate 206. Then, the first shell element 110 is pulled up to separate the hook 202 from the hollow 212. Thus, the first shell element 110 is separated from the second shell element 112, as shown in FIG. 2.

To close the first shell element 110 against the second shell element 112, one end having the second hole 202b of the hook 202 is inserted into the hollow 212. Then, the button 204 is pressed by the finger 216 to push the stopper 204a of the button 204 carrying the hook 202 and the resilient plate 206 inside the first shell element 110 to move the hook 202 backward and deform the resilient plate 206. The hook 202 falls by gravity to align with the second hole 202b at the protrusion 214, as shown in FIG. 5. After releasing the button 204, the restoring force of the resilient plate 206 produced by compressing the resilient plate 206 pushes the hook 202 outside the first shell element 110 to clasp the hook 202 and the protrusion 214, as shown in FIG. 4. The first shell element 110 and the second shell element 112 are thus closed.

Alternatively, the first hole 202a of the hook 202 can be clasped with the protrusion of the second engagement device 210 according to the demands. FIG. 6 is a schematic diagram showing a tablet personal computer with the screen display flipped over according to one embodiment of the present invention. In FIG. 6, the screen display 118 is upward after flipping over the first shell element 110. The first hole 202a of the hook 202 is clasped with the protrusion 214 of the second shell element 112. Thus, the hook 202 can be slid up and down according to the demands. The hook 202 can be protruded from the front side and the back side of the first shell element 110 selectively. The first hole 202a of the hook 202 can be clasped with the second engagement device 210 while the screen display 118 is upward. The second hole 202b can be clasped with the second engagement device 210 while the screen display 118 is downward.

Thus, the present invention provides a latch device to latch a front side or a back side of a screen display onto a base to enhance operation convenience. Moreover, the hook of the latch device of the present invention can be repositioned quickly after flipping over the first shell element of the tablet personal computer. Furthermore, the latch device of the present invention provides the hook sliding up and down to protrude from the front side and the back side of the first shell element. Besides, the latch device of the present invention can decrease damage of the hollow and maintain the appearance of the tablet personal computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A latch device applied in a tablet personal computer, wherein the tablet personal computer comprises a first shell element having a front side and a back side, and a second shell element pivotally coupled with one end of the first shell element, the latch device comprising:
a first engagement device mounted on the first shell element, wherein the first engagement device comprises:
a hook having a sliding cavity, a first hole and a second hole, wherein the first hole and the second hole are positioned symmetrically in two ends of the hook, and the sliding cavity comprises a long axis and a short axis;
a resilient plate mounted against the hook; and
a button having a stopper and a bulge protruding from the stopper and contacting the resilient plate, wherein the stopper presses on the hook, and the bulge passes through the sliding cavity to slide along the long axis of the sliding cavity to selectively let an end having the first hole of the hook protrude from the front side of the first shell element or an end having the second hole of the hook protrude from the back side of the first shell element; and
a second engagement device mounted on the second shell element, wherein the second engagement device comprises:
a hollow used to contain the hook; and
a protrusion in the hollow to clasp the first hole and the second hole selectively.

2. The latch device for personal computer of claim 1, wherein the protrusion is a projection.

3. The latch device for personal computer of claim 1, wherein the button is pressed to deform the resilient plate to release or clasp the first hole relative to the second hole.

4. A latch device, wherein the latch device is applied in a tablet personal computer comprising a first shell element having a front side and a back side, and a second shell element pivotally coupled with one end of the first shell element, the latch device comprising:
a hook having a sliding cavity, a first hole and a second hole, wherein the first hole and the second hole are positioned symmetrically in two ends of the hook, and the sliding cavity comprises a long axis and a short axis;
a resilient plate mounted against the hook; and
a button having a stopper and a bulge protruding from the stopper and contacting the resilient plate, wherein the stopper presses on the hook and the bulge passes through the sliding cavity to slide along the long axis of the sliding cavity to selectively let an end having the first hole of the hook protrude from the front side of the first shell element or an end having the second hole of the hook protrude from the back side of the first shell element.

5. The latch device of claim 4, wherein the button is pressed to deform the resilient plate to release or clasp the first hole relative to the second hole.

6. A tablet personal computer, the tablet personal computer comprising:
a first shell element having a front side and a back side;
a second shell element pivotally coupled with one end of the first shell element, wherein the first shell element can be flipped over relative to the second shell element to make the front side or the back side toward the second shell element; and
a latch device, the latch device comprising;
a first engagement device mounted on the first shell element, wherein the first engagement device comprises:
a hook having a sliding cavity, a first hole and a second hole, wherein the first hole and the second hole are positioned symmetrically in two ends of the hook, and the sliding cavity comprises a long axis and a short axis;
a resilient plate mounted against the hook; and
a button having a stopper and a bulge protruding from the stopper and contacting the resilient plate, wherein the stopper passes on the hook, and the bulge is passed through the sliding cavity to slide along the long axis of the sliding cavity to selectively let an end having the first hole of the hook protrude from the front side of the first shell element or an end having the second hole of the hook protrude from the back side of the first shell element; and
a second engagement device mounted on the second shell element, wherein the second engagement device comprises:
a hollow used to contain the hook; and
a protrusion in the hollow to clasp the first hole and the second hole selectively.

7. The tablet personal computer of claim 6, wherein the protrusion is a projection.

8. The tablet personal computer of claim 6, wherein the button is pressed to deform the resilient plate to release or clasp the first hole relative to the second hole.
